(19) United States
(12) Patent Application Publication
(10) Pub. No.: US 2002/0087735 A1
(43) Pub. Date: Jul. 4, 2002

(54) Software ICs or PALs for high level application frameworks

(76) Inventors: Hans-Erich Reinfelder, Erlangen (DE); Karlheinz Dorn, Kalchreuth (DE); Detlef Becker, Moehrendorf (DE); Dietrich Quehl, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 09/773,949

(22) Filed: Feb. 1, 2001

Related U.S. Application Data
(63) Continuation-in-part of application No. 08/675,846, filed on Jul. 3, 1996, now abandoned.

(51) Int. Cl. G06F 9/00

(52) U.S. Cl. 709/310

(57) ABSTRACT

An object oriented computing system, comprising objects with semanticless, dynamically likable inputs and outputs; and an event communication framework providing automated, pattern-based, fully distributable events.

### RELATED APPLICATION

The present application is a continuation-in-part (CIP) of copending U.S. Ser. No. 08/675,846 filed Jul. 3, 1996 and entitled “SOFTWARE ICS OR PALS FOR HIGH LEVEL APPLICATION FRAMEWORKS” of the same inventors herein.

### BACKGROUND OF THE INVENTION

The present invention generally is directed to object oriented multi-programming systems. More, particularly, the invention is directed to methods and means for interconnecting software components or building blocks.

As set forth in U.S. Pat. No. 5,499,365, full incorporated herein by reference, object oriented programming systems and processes, also referred to as “object oriented computing environments,” have been the subject of much investigation and interest. As is well known to those having skill in the art, object oriented programming systems are composed of a large number of “objects.” An object is a data structure, also referred to as a “frame,” and a set of operations or functions, also referred to as “methods,” that can access that data structure. The frame may have “slots,” each of which contains an “attribute” of the data in the slot. The attribute may be a primitive (such as an integer or string) or an object reference which is a pointer to another object. Objects having identical data structures and common behavior can be grouped together into, and collectively identified as a “class.” Each defined class of objects will usually be manifested in a number of “instances”. Each instance contains the particular data structure for a particular example of the object. In an object oriented computing environment, the data is processed by requesting an object to perform one of its methods by sending the object a “message”. The receiving object responds to the message by choosing the method that implements the message name, executing this method on the named instance, and returning control to the calling high level routine along with the results of the method. The relationships between classes, objects and instances traditionally have been established during “build time” or generation of the object oriented computing environment, i.e., prior to “run time” or execution of the object oriented computing environment.

In addition to the relationships between classes, objects and instances identified above, inheritance relationships also exist between two or more classes such that a first class may be considered a “parent” of a second class and the second class may be considered a “child” of the first class. In other words, the first class is an ancestor of the second class and the second class is a descendant of the first class, such that the second class (i.e., the descendant) is said to inherit from the first class (i.e., the ancestor). The data structure of the child class includes all of the attributes of the parent class.

Object oriented systems have heretofore recognized “versions” of objects. A version of an object is the same data as the object at a different point in time. For example, an object which relates to a “work in progress”, is a separate version of the same object data which relates to a completed and approved work. Many applications also require historical records of data as it existed at various points in time. Thus, different versions of an object are required.

Two articles providing further general background are E. W. Dijkstra, The Structure of “THE” Multiprogramming System, Communications of the ACM, Vol. 11, No. 5, May 1968, pp. 341-346, and C.A.R. Hoare, Monitors. Operating Systems Structuring Concepts, Communications of the ACM, Vol. 17, No. 10, October, 1974, pp. 549-557, both of which are incorporated herein by reference. The earlier article describes methods for synchronizing using primitives and explains the use of semaphores while the latter article develops Brinch-Hansen's concept of a monitor as a method of structuring an operating system. In particular, the Hoare article introduces a form of synchronization for processes and describes a possible method of implementation in terms of semaphores and gives a proof rule as well as illustrative examples.

As set forth in the Hoare article, a primary aim of an operating system is to share a computer installation among many programs making unpredictable demands upon its resources. A primary task of the designer is, therefore, to design a resource allocation with scheduling algorithms for resources of various kinds (for example, main store, drum store, magnetic tape handlers, consoles). In order to simplify this task, the programmer tries to construct separate schedulers for each class of resources. Each scheduler then consists of a certain amount of local administrative data, together with some procedures and functions which are called by programs wishing to acquire and release resources. Such a collection of associated data and procedures is known as a monitor.

The adaptive communication environment (ACE) is an object-oriented type of network programming system developed by Douglas C. Schmidt, an Assistant Professor with the Department of Computer Science, School of Engineering and Applied Science, Washington University. ACE encapsulates user level units and WIN32 (Windows NT and Windows 95) 05 mechanisms via type-secured, efficient and object-oriented interfaces:

IPC mechanisms—Internet-domain and UNIX-domain sockets, TLI, Named pipes (for UNIX and Win 32) and STREAM pipes;

Event multiplexing—via select( ) and poll( ) on UNIX and WaitForMultipleObjects on Win 32;

Solaris threads, POSIX Pthreads, and Win 32 threads;

Explicit dynamic linking facilities—e.g., dlopen/dlsym/dlclose on UNIX and Load Library/GetProc on Win 32;

Memory-mapped files;

System VIPC—shared memory, semaphores, message queues; and

Sun RPC (GNU rpc++).

In addition, ACE contains a number of higher-level class categories and network programming frameworks to integrate and enhance the lower-level C++ wrappers. The higher-level components in ACE support the dynamic configuration of concurrent network daemons composed of application services. ACE is currently being used in a number of commercial products including ATM signaling software products, PBX monitoring applications, network management and general gateway communication for mobile communications systems and enterprise-wide distributed medical systems. A wealth of information and documentation regarding ACE is available on the worldwide web at the following universal resource locator:

http://www.cs.wustl.edu/. . . schmidt/A CE-overview, html.

The following abbreviations are or may be utilized in this application:

Thread—a parallel execution unit within a process. A monitor synchronizes, by forced sequentialization, the parallel access of several simultaneously running Threads, which all call up functions of one object that are protected through a monitor.

Snchronizations-Primitive—a means of the operating system for reciprocal justification of parallel activities.

Semaphore—a Synchronizations-Primitive for parallel activities.

Mutex—a special Synchronizations-Primitive for parallel activities, for mutual exclusion purposes, it includes a critical code range.

Condition Queue—an event waiting queue for parallel activities referring to a certain condition.

Gate Lock—a mutex of the monitor for each entry-function, for protection of an object, for allowing only one parallel activity at a time to use an Entry-Routine of the object.

Long Term Scheduling—longtime delay of one parallel activity within a condition queue or event waiting queue for parallel activities.

Broker—a distributor.

In addition, the following acronyms are or may be used herein:

| | |
|---|---|
| AFM | Asynchronous Function Manager |
| SESAM | Service & Event Synchronous Asynchronous Manager |
| PAL | Programmable Area Logic |
| API | Application Programmers Interface |
| IDL | Interface Definition Language |
| ATOMIC | Asynchron Transport Qptimizing observer- |
| | pattern-like system supporting several Modes |
| | (client/server-push/pull) for an IDL-less |
| | Communication subsystem (This is the subject |
| | of commonly assigned and copending |
| | application Serial No. 08/676,859, Attorney |
| | Docket No. P96,0462) |
| XDR | External Data Representation |
| I/O | Input/Output |
| IPC | Inter Process Communication |
| CSA | Common Software Architecture (a Siemens AG |
| | computing system convention) |
| SW | Software |

In the past, interface of software components or building blocks has been hard coded in an application program interface (API). This solution was linkable into a process, but was neither configurable nor location transparent. Additionally, the interface has been provided by way of an interface definition language (IDL) with hard coded object references. It was not possible to alter an existing configuration without changing and recompiling the code. FIG. 4 shows the difference between the way applications in the past have been connected and the way the present invention provides.

### SUMMARY OF THE INVENTION

The present invention provides a method and/or means for combining and configuring independent, software components or building blocks with semantic-less input and output configuration into large applications, without changing any code within the building blocks (components) and without writing any adapters. To that end, the functionality of a module or building block is fully separated from the surrounding environment, so that it need not be located within the same process, and can instead be distributed over a network, without the need of changing an interface definition language or any object reference.

In an embodiment, the invention provides a method for designing software modules comprising the steps of:

defining input and output events that are fully distributable;

configuring dynamic loadable, software modules (components) by input and output connections points which do not depend on the semantics of the component;

providing autorouted pattern based fully distributable events based on an event communication framework.

In an embodiment, the invention provides an object oriented computing system, comprising components with semanticless, dynamically connectible inputs and outputs; and an event communication framework providing automated, pattern-based, fully distributable events.

In an embodiment, the inputs and outputs of the components are provided by means of CsaConnectable and CsaRemote objects, respectively.

In an embodiment, each component is implemented as a shared library which is dynamically loadable at runtime by means of an ASCII configuration file which is also dynamically connectible to other components of this type through configurable naming of the inputs and outputs by means of managing logical connections based on partnerships, as set forth in copending application Ser. No. 08/676,859.

In an embodiment, each component is a shared library which is dynamically loadable at runtime by an ASCII configuration file containing the names of the input and output connection points of the component.

These and other features of the invention are discussed in greater detail below in the following detailed description of the presently preferred embodiments with reference to the accompanying drawings.

### BRIEF DESCRIPTION OF THE DRAWINGS

FIG. 1 illustrates a comparison of hardware and software ICs;

FIG. 2 illustrates an application utilizing software ICs;

FIG. 3 illustrates a comparison of hardware PALs and software PALs;

FIG. 4 illustrates in block diagram format differences between the way past applications have been connected and the present invention;

FIG. 5 illustrates a sample use case formed of three components and one main program;

FIG. 6 illustrates an output connection point of a number generator, an input connection point of a multiplier component, an output connection point of the multiplier component, and an input connection point of a printer component; and

FIG. 7 shows a configuration of an output connection point of a number generator, an input connection point of a multiplier component, an output connection point of the multiplier component, and an input connection point of a printer component.

### COPENDING APPLICATIONS

The following commonly assigned copending applications are incorporated herein by reference:

| | Application | | Attorney |
|---|---|---|---|
| Title | Serial No. | Filing Date | Docket No. |
| MONITOR FOR SYN- | 08/675,846 | July 3, 1996 | P96,0460 |
| CHRONIZATION OF | | | |
| THREADS WITHIN A | | | |
| SINGLE PROCESS | | | |
| SERVICE AND EVENT | 08/675,616 | July 3, 1996 | P96,0461 |
| SYNCHRONOUS/ASYN- | | | |
| CHRONOUS MANAGER | | | |
| ASYNCHRONOUS | 08/676,859 | June 22, 1998 | P96,0462 |
| TRANS-PORT | | | |
| OPTIMIZING OB- | | | |
| SERVER-PATTERN LIKE | | | |
| APPROACH | | | |
| SUPPORTING | | | |
| SEVERAL MODES FOR | | | |
| AN INTERFACE DEFINI- | | | |
| TION LANGUAGE-LESS | | | |
| COMMUNICATION SUB- | | | |
| SYSTEM | | | |

### DETAILED DESCRIPTION OF THE PREFERRED EMBODIMENTS

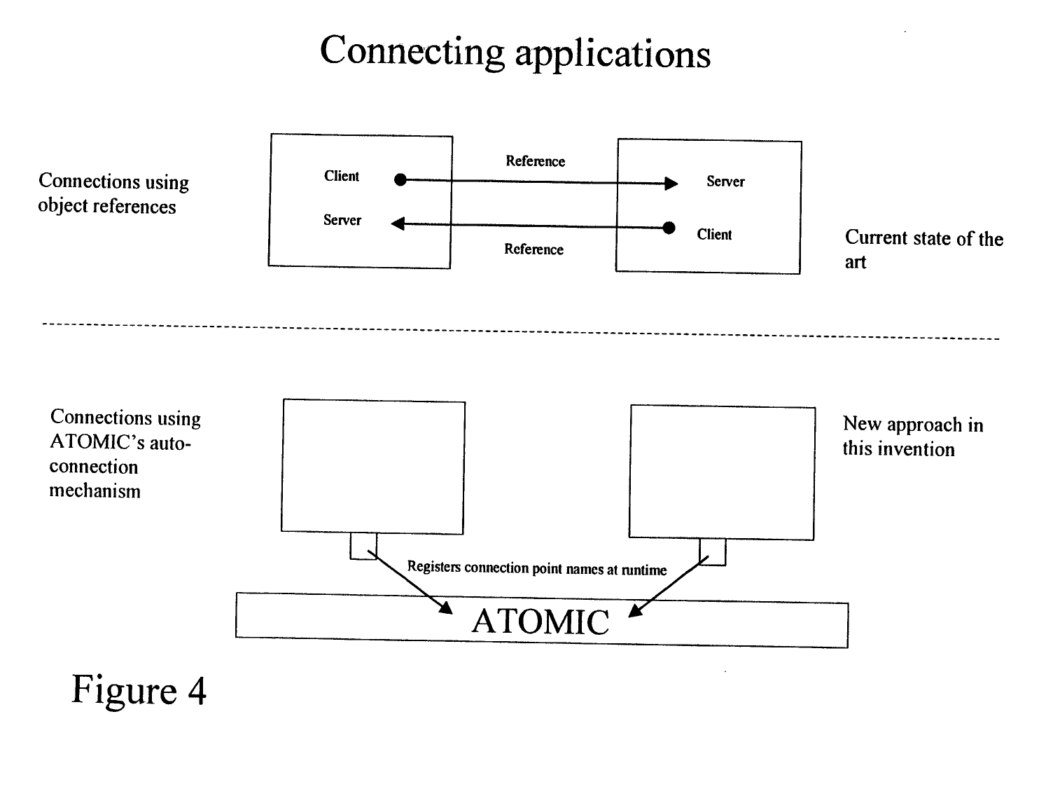

FIG. 4 shows a difference between the way applications in the past have been connected and the way the present invention provides.

As set forth above, the present invention provides an approach for combining independent, building blocks (components) into larger applications without changing any code within the building blocks and without writing any adapters. The result is a system or architecture wherein software blocks can be combined in the same manner that integrated circuits are combinable.

In the past the functionality of a software system was realized by means of object files and/or libraries which in turn have been linked into executable programs. Informations about connections to other executable programs have been hard coded. Changes of a software system consisting of several executable programs like e.g.

enhancing the functionality or

changing the connectivity to the outside environment of such an executable program or

changing the location, at which a functionality has to be executed (e.g. a different executable program running on the same computer or on a different computer) always caused changes to the program code combined with recompilation and re-linking of the program code.

For the purposes of this invention, the way functionality is implemented is building components (the software ICs or “SWIC”). A component (SWIC) is a shared library consisting of a well defined API, and a factory method which instantiates the component after dynamic loading (see BUILDING BLOCK IMPLEMENTATION). This well defined API which is implemented by the component and which is also known the main program can be named a contract between the hosting main pro- gram and the component(s).

A main program based on the dynamic linking facility of ACE loads one or more of such components and calls the initial method of each component. The init( ) method serves as the initialization hook of the component. ACS' dynamic linking facility can pass command line arguments to the init( ) method just the same way as also known from a C/C++ main program's argument list. ACE' dynamic linking facility supports dynamic unloading of components at runtime, too. The component's fini( ) method serves as the destruction hook of the component and will be invoked before the component is unloaded in order to perform necessary cleanup operations.

The information about which components have to be loaded by the main program is specified via one or more load statements (dynamic . . . ) in an ASCII configuration file as described hereafter. A main program can process one configuration file at its startup time.

As there is no need to implement other functionality than loading all the components specified in the configuration file into the hosting main program, several instances of the same main program can be used in combination with several configuration files to build a complex application framework. The main program thus can be named a generic main program.

The functionality implemented in such a component can be reconfigured into other hosting main programs either on the same computer or on a different computer at the network by removing the load statement from one main program's ASCII configuration file and inserting it into a different main program's configuration file. Doing so, the functionality is moved into an other hosting main program without program code changes, without re-compilation, and without re-linking the program.

For the purposes of this invention, the way a software building block (component) connects to its outside environment (which may consist of one or more other building blocks (components) as well as user written code) is via CsaConnectable (supplier or sender connection point) and CsaRemote (consumer or receiver connection point), regardless whether the other endpoint of the connection resides in the same process or on a remote computer (with optimization of the underlying communication protocol, if in-process transfers are detected by the communication framework). This rule is applied to all building blocks (components). For further information regarding the CsaConnectable and CsaRemote connection points, reference should be made to the commonly assigned and copending applications incorporated by reference above, and in particular Ser. Nos. 08/675,616 and 08/676,859, Attorney Docket Nos. P96,0461 and P96,0462, respectively.

Both types of connection points, CsaConnectable as well as CsaRemote, do not have any object references to their corresponding connection points. The connection points register themselves at the ATOMIC communication framework via a name string at instantiation time. The name string is a simple ASCII string.

At the time a sender (CsaConnectable) sends data, ATOMIC determines which receivers (CsaRemote) with the same name string associated to them currently exist. It dynamically connects these receivers to the sender, regardless wether the receivers reside withing the same executable program (process), in a different process on the same computer or on an other computer on the network. That's the way location transparency is realized.

This auto-connection mechanism takes place for every transfer from CsaConnectable to CsaRemote and thus reconfiguring components at runtime do not affect the reliable connections between these components.

The auto-connection mechanism does not depend on the data structure transferred between CsaConnectable and CsaRemote and thus its independent from the semantics of the components.

In the present invention, the name strings that identify the input and output connection points (CsaRemote and CsaConnectable) are not declared as part of the program code. These names can be appended to the load statement in the configuration file. After loading the component ACE' dynamic linking facility passes these name strings as command line options to the init( ) method of the component. The init( ) method in turn creates new instances of the connection points using these name strings obtained from the argv[ ] argument of the init( ) method. This mechanism is the foundation of a configurable application framework.

A sample use case that gives an impression of the capabilities is illustrated hereafter.

The semantic of a component is defined by the structure of the data received by the input connection points, the operations performed on these data, and the structure of the data send through the output connection points.

In the present invention this semantic is precisely separated from the auto-connection mechanism, which connects the inputs and outputs of a component with the inputs and outputs of other components.

As described hereafter, the input and output data structures are defined as C++ classes and as usual in C/C++ program code, class definitions are done in a separate header file.

The great advantage of this approach is that a flexible and high level software IC arises from the optimal combination of other simple, well designed, software ICs. Again, this mechanism is very similar to combining integrated circuits on boards in the hardware world. The pins of a hardware IC correspond to the connection points of a software IC and the logic implemented in a hardware IC corresponds to the program code implemented in a software IC (component). The way the pins of a hardware IC are wired on a board corresponds to the auto-connection mechanism of ATOMIC.

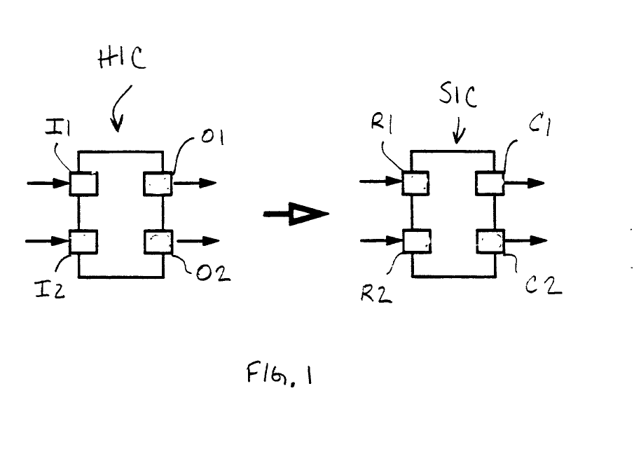

FIG. 1 is useful for comparing the similarities between hardware integrated circuits (ICs) and the present software objects. In FIG. 1, a hardware ICHIC has two input pins I1 and I2 and two output pins 01 and 02. Similarly, the software object SIC has two inputs R1 and R2 via CsaRemote and two outputs C1 and C2 via CsaConnectable.

An example of coding for implementing such a software IC system is illustrated as follows.

I. INPUT/OUTPUT CLASS DECLARATIONS
#ifndef SAMPLECLASS1H
#define SAMPLECLASS1H
/******************************\

| | |
|---|---|
| * | * |

* Input/Output data structure *

| | |
|---|---|
| * | * |

/******************************\
struct SampleClass1 {

| | |
|---|---|
| int | theInteger; |

DECLARE_MSC (SampleClass1)

};
IMPLEMENT_MSC (SampleClass1, V(theInteger))
#endif// SAMPLECLASS1H
#IFNDEF SAMPLECLASS2H
#define SAMPLECLASS2H
/******************************\

| | |
|---|---|
| * | * |

* Input/Output data structure *

| | |
|---|---|
| * | * |

/******************************\
struct SampleClass2 {

int theInteger;
DECLARE_MSC (SampleClass2)

};
IMPLEMENT_MSC (SampleClass2, V(theInteger))
#endif// SAMPLECLASS2H
II.. BUILDING BLOCK HEADER FILE
#include<ace/Service_Object.h>
#include<CsaConnectable.hh>
#inc1ude<CsaRemote.hh>
#include<SampleClass1.h>
#include<SampleClass2.h>
class SampleApplication : public ACE_Service_Object
{

public:

virtual int init (int, char* *);
virtual int fini (void);
virtual int info (char* *, size_t) const;
SampleApplication (void);
- SampleApplication (void);

protected:

CsaConnectable <SampleClass 1> *output1;
CsaConnectable <SampleClass2> *output2;
CsaRemote <SampleClass 1> *input1;
CsaRemote <SampleClass2> *input2;

};
#endif/ / SAMPLE_APPLICATION
III. BUILDING BLOCK IMPLEMENTATION
#include<CsaConnectable.h>
#include<CsaRemote.hh>
#include<SampleApplication.h>
int SampleApplication::init(int argc, char * *argv) {

cout << endl <<“Initializing” <<end 1;
input1 new CsaRemote <SampleClassi> (argv[1]);
input2 = new CsaRemote <SampleClass2> (argv[2]);
output1 = new CsaConnectable <SampleClass1> (argv[3]);
output2 = new CsaConnectable <SampleClass2> (argv[4]);
return (0);

}
int SampleApplication::fini (void) {

cout << endl <<“Finalizing“ <<end 1 <<end 1;
delete input1;
delete input2;
delete output1;
delete input1;
return (0);

}
int SampleApplication: : info(char**, unsigned) const {

cout << endl <<“Returning infos about” <<end 1;
return (0);

}
SampleAppliction::SampleApplictaion(void) { }
SampleApplication::˜SampleApplication(void) { }
/* Dynamically linked functions used to control configurations */
extern ″C″ ACE_Service_Object*_alloc(void);
ACE_Service_Object * alloc (void) { return (ACE_Service_Object *)
new SampleApplication;
}
IV. ASCII CONFIGURATION FILE
static SVC_Manager ″-d -p 3333″
dynamic SampleApplication

ACE_Service Object * ./SampleApplication.so:_alloc( )
″SampleApplication in1_name in2_name out1_name
out2_name″

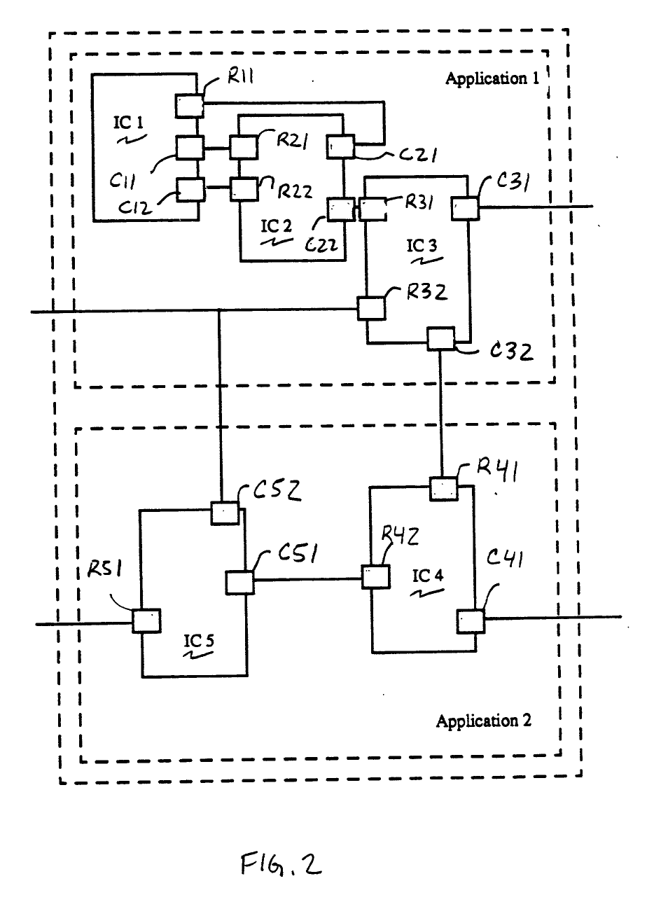

In FIG. 2 there is illustrated in block diagram form a possible implementation of software ICs in a system with more than one application. In FIG. 2 there are illustrated five software ICs: IC 1, IC2, IC3, IC4 and IC5. Additionally, there are two applications, Application 1 and Application 2, employing the software ICs. Application 1 contains software ICs IC 1, IC2 and IC3, while Application 2 contains software ICs IC4 and IC5. As can be seen, Application 1 and Application 2 interact with each other, as well as externally of the process or system containing Application 1 and Application 2, via inputs and outputs of the software ICs.

As illustrated, ICi has two inputs C11 and C12. ICi also has one output via R11. The inputs C11 and C12 are connected to two outputs of IC2, R21 and R22, respectively. An input C21 of IC2 is connected to the output Ri 1 of ICi.

IC3 has an output R3 1 connected to the input C22 of IC2, and input C3 1 connected externally of the process containing the applications, an input C32 connected to an output R41 of IC4 and an output R32 connected to an input C52 of ICS and externally of the system. In addition to output R41, IC4 has a input C41 connected externally of the system and an output R42 connected to an input CS 1 of the IC5. IC5 also has an output R5 1 connected externally of the process or system containing the applications.

The inputs and output are via CsaConnectable and CsaRemote as described above. Moreover, the data are autorouted to the various inputs and outputs via dynamic linking, thereby allowing changing the configuration and interaction of the applications without requiring recompilation or relinking.

In addition, the foregoing software IC principles can be combined with a pattern (task) from ACE, to obtain a very powerful software building block that behaves like a hardware PAL, and that offers the power of synchronous behavior within the building block and asynchronous behavior/interaction outside of the building block.

The internal processing rate (the counterpart to a clock rate in a hardware PAL) is thus fully independent from the event input/output rate of the connected environment. The necessary buffering to achieve the synchronization is also provided without concern to semantics. Similar to hardware PAL synchronization solutions, the synchronization task can be configured into a software PAL, as needed.

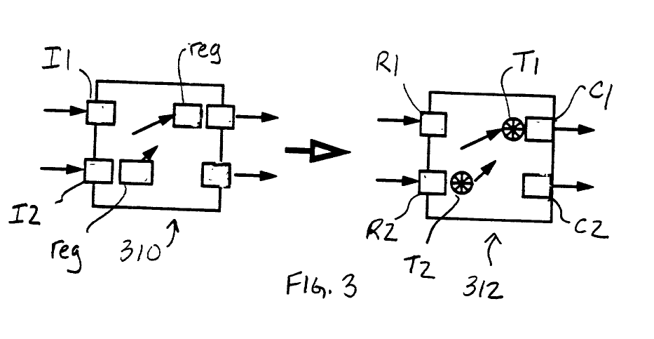

FIG. 3 illustrates a comparison between hardware PALs and Software PALs. As illustrated, a hardware PAL 310, like a hardware IC, can have two input pins 11 and 12 and two output pins 01 and 02. However, within the hardware PAL 310 there also are provided registers/buffers reg in which incoming and outgoing data or signals are stored.

The counterpart software PAL 312 has inputs Ri and R2 and outputs Ci and C2 like the software IC described previously. However, also illustrated are tasks Ti and T2 that replace the registers/buffers reg of the hardware PAL 310. In other respects, the software PAL is similar to a software IC, as described above.

A software PAL provides inner logic flexibility to a software IC by means of active object support. Incoming events are able to be buffered by tasks, such as the task Ti, before further processing by the inner logic. Further, outgoing events can be taken from a buffer, such as the task T2, thereby decoupling the events from the inner logic of the software PAL.

V. Sample Use Case

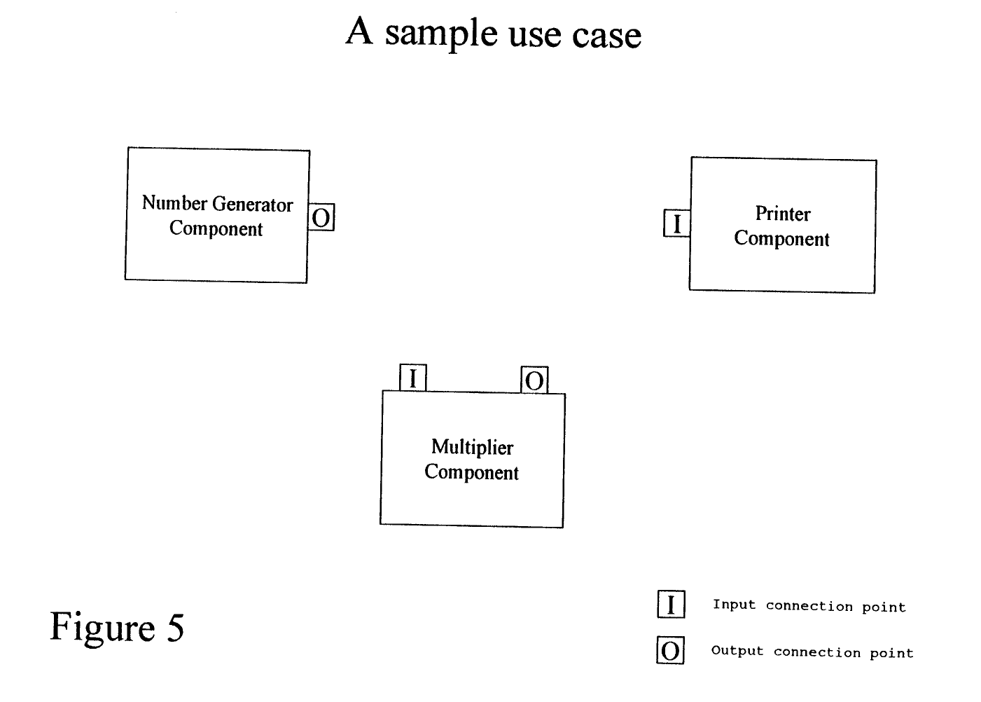

FIG. 5 shows a sample use case formed of three components and one main program. The main program is started with the configuration file name as a command line argument, processes the load statement found in the specified configuration file, and loads and initializes that particular component. As the only task the main program performs is to read and process configuration files which are specified as a command line argument, the same main program can be used for all components and thus it is named the generic main program.

The first of the three components in this sample use case is a number generator “NumGen” that generates integer numbers in the range between 0 and 4 in ascending order. It sends the numbers through its output connection point. The name of the output connection point is configured via the configuration file as part of the load statement. The component reads this name in its init( ) method from the argv[ ] argument.

The second component is a printer component “Printer” that receives numbers at its input connection point and simply prints the numbers. The name of the input connection point is configured via the configuration file as part of the load statement. The component reads this name in its init( ) method from the argv[ ] argument.

The third component is a multiplier component “Multiplier” which receives numbers at its input connection point, doubles them and sends the results through its output connection point. The names of the input and output connection points are configured via the configuration file as part of the load statement. The component reads this names in its init( ) method from the argv[ ] argument.

The two configurations shown in this sample use case illustrate how the functionality of an application framework can be modified by reconfiguring components without any changes in the source code. The application framework's functionality can be modified by simply changing the connection point names in an ASCII configuration file or by substituting one component by a component with different functionality and identical connection point names.

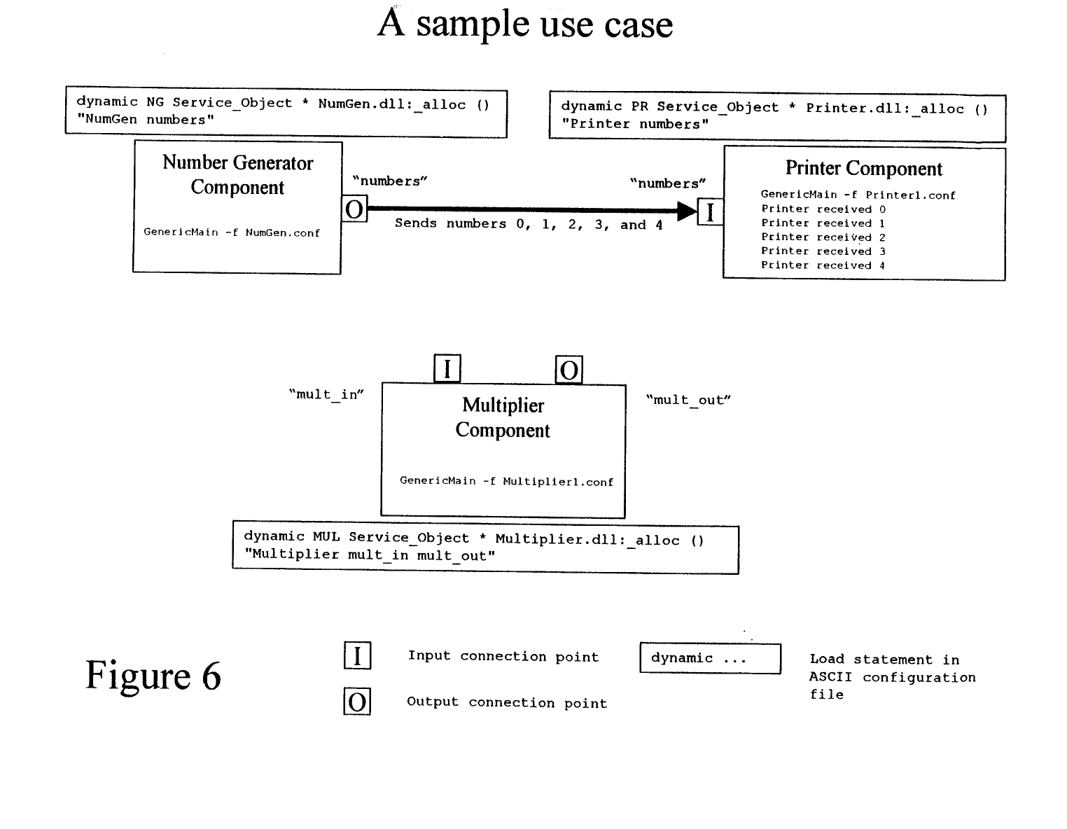

FIG. 6 shows a configuration where the output connection point of the number generator component is named “numbers”, the input connection point of the multiplier component is named “mult_in”, the output connection point of the multiplier component is named “mult_out”, and the input connection point of the printer component is named “numbers”. As ATOMIC's auto-connection mechanism dynamically connects connection points with identical names, the output connection point of the number generator component will be connected to the input connection point of the printer component. The printer component receives the numbers generated by the number generator component and prints them out. The input and output connection points of the multiplier component do not match the connection point names of any of the other components and thus it will not be connected.

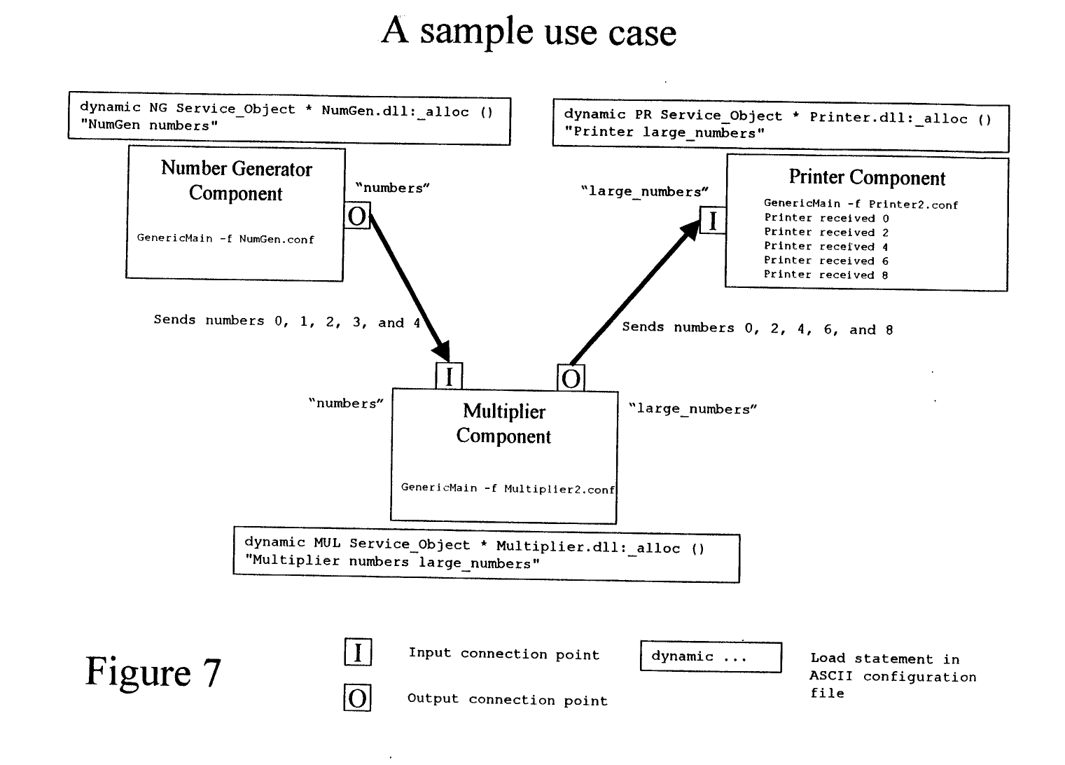

FIG. 7 shows a configuration where the output connection point of the number generator component is named “numbers”, the input connection point of the multiplier component is named “numbers”, the output connection point of the multiplier component is named “large_numbers”, and the input connection point of the printer component is named “large_numbers”. As ATOMIC's auto-connection mechanism dynamically connects connection points with identical names, the output connection point of the number generator component will be connected to the input connection point of the multiplier component. The output connection point of the multiplier component will be connected to the input connection point of the printer component. The multiplier component receives the numbers generated by the number generator component, doubles them, and sends the doubled numbers through its output connection point. The printer component receives the numbers sent by the multiplier component and prints them out.

Program-Code and ASC II Configuration Files for the Sample Use Case
Datei: Data.ccp
#include “Data.h”
IMPLEMENT_MSC_EXP (Data, _declspec (dllexport),G(int1))
Datei: Data.h
#ifndef Data_H
#define Data_H
#include <osc/CsaConnectable.h>
#inc1ude <osc/CsaRemote.h>
class_doc1spec (dllexport) Data {
public;

Date (void) : intl (0) { }
int intl;
DECLARE_MSC_EXP (Data, _dec1spec (dllexport));

};
#endif//Data_H
Datei: GenericMain.ccp
#include <ace/Service_Config.h>
int main(int argc, char* argv[ ])
(

ACE_Service Config daemon;
if(docmon.open (argc.argv) − = −1)

return 1;

return 0;

}
Datei: Multiplier.ccp
#include “Multiplier.h”
Multiplier::Multiplier (void) : input(NULL), output(NULL) { }
Multiplier::˜Multiplier(void) { }
int Multiplier::init (int argc, char* argv[ ]) {

input = new CsaRemote <Data> (argv[1]);
output = new CsaConnectable <Data> (argv[2]);
Data data;
int i;
for (i = 0; i<5; i++) {

input −> getValue (data);
data.intl *= 2;
output −> setValue (date);

}
return (0);
}
int Multiplier::fini (void) {

if (input!—NULL)

delete input;

input = NULL;
if (output!—NULL)

delete output;

output = NULL;
return (0);

}
int Multiplier::info (char** info, size t infoSize) const {

return (0);

}
// Factory function called by ACE' dynamic linking facility
ACE_Service_Object *_alloc (void) {
return (ACE Service Object *) new Multiplier;
}
Datei: Multiplier.h
#ifndef Multiplier_H
#define Multiplier H
#include <ace/Service_Object.h>
#include <osc/CsaConnectable.h>
#include <osc/CsaRemote.h>
#include “Data.h”
class Multiplier : public ACE Service Object
{
public:

Multiplier (void);
˜Multiplier (void);
virtual int init (int argc, char* argv[ ])}
virtual int fini (void);
virtual int info (char** info, size t infoSize) const;

private:

CsaRemote <Data> *input;
CsaConnectable <Data> *output;

}
extern “C”_dec1spec (dllexport) ACE_Service Object

*_alloc(void);

#endif// Multiplier_H
Datei: MultiplierI.conf
dynamic MUL Service_Object * Multiplier.dll:_alloc ( ) “Mul-

tiplier mult_in mult_out”

Datei: Multiplier2.conf
dynamic MUL Service_Object * Multiplier.dll:_alloc ( ) “Mul-
tiplier numbers large_numbers”
Datei: NumGen.conf
dynamic NG Service_Object * NumGen,dll:_alloc ( ) “NumGen num-
bers”
Datei: NumGen.ccp
#include “NumGen.h”
NumGen::NumnGen (void) output : (NULL) { }
NumGen::˜NumGen(void) { }
int NumGen::init (int argc, char* argv [ ]) {

output = new CsaConnectable (Data> (argv:] ]);
Data data;
for (data.intl—0; data.intl<5; data.intl++)

output−> setValue(data);

return (0);

}
int NumGen::fin1 (void) {

if (output! = NULL)

delete output;

output = NULL;
return (0);

}
int NumGen::info (char** info, size_t infoSize) const {

return (0);

}
// Factory function called by ACE' dynamic linking facility
ACE_Service-Object *_alloc (void) {

return (ACE Service_Object *) new NumGen;

}
Datei: NumGen.h
#ifndef NumGen_H
#define NumGen_H
#include <ace/Service_Object.h>
#include <osc/CsaConnectable.h>
#include <osc/CsaRemote.h>
#include “Data.h”
class NumGen : public ACE Service Object
{
public:

NumGen (void);
˜NumGen (void);
virtual int init (int argc, char* argv[ ]);
virtual int fini (void);
virtual int info (char** info, size_t infoSize) const;

private:

CsaConnectable <Data> *output;

};
extern “C”_dec1spec (dllexport) ACE_Service_Object

*_alloc (void);

#endif// NumGen_H
Datei: Printer.ccp
#include “Printer.h”
Printer::Printer(void) : input(NULL) {)
Printer::˜Printer (void) { }
int Printer::init(int argc, char ˜ argv [ ]) {

input new CsaRemote <Data> (argv [1]);
Data data;
int i;
for (i=0; i<5; i++ {

input −> getValue (data);
cout << “Printer received” << data.intl << end1;

}
return (0);

}
int Printer::fini (void) {

if (input = NULL)

delete input;

input = NULL;
return (0);

}
int Printer::irifo (char** info, size_t infoSize) const. { return (0);
}
// Factory function called by ACE' dynamic linking facility
ACE_Service Object * alloc (void) (

return [ACE Service Object *) new Printer;

}
#Ifndef Printer_H
#define Printer_H
#include <ace/Sorvice_Object.h>
#include <osc/CsaConnectable.h>
#include <osc/CsaRemote.h>
#include “Data.h”
class Printer : public ACE Service Object
{
public:

Printer (void);
˜Printer (void);
virtual Int init (int argc, char* argv [ ]);
virtual int fini (void);
virtual int info (char** info, size t infoSize) const;

private:

CsaRemote <Data> *input;

};
extern “C” dec1spec (dllexport) ACE Service_Object

*_alloc(void);
#endif// Printer H
Datei: Printer1 .conf
dynamic PR Service Object * Printer.dll: alloc ( ) “Printer
numbers”

Datei: Printer2.conf
dynamic PR Service_Object * Printer.dll: alloc ( ) “Printer

large_numbers”

Although modifications and changes may be suggested by those skilled in the art, it is the intention ofthe inventors to embody within the patent warranted hereon all changes and modifications as reasonably and properly come within the scope of their contribution to the art.

1. An object oriented computing system on a computer platform, comprising:
objects with semanticless, dynamically likable inputs and outputs; and
an event communication framework providing automated, pattern-based, fully distributable events.

2. The object oriented computing system of claim 1, wherein the inputs and outputs of the objects are provided via CsaConnectable and CsaRemote objects, respectively.

3. The object oriented computing system of claim 2, wherein each data structure associated with the inputs and outputs is described in a separate header file which can be used by every object to be linked.

4. The object oriented computing system of claim 2, wherein each object is a shared library which is dynamically likable at runtime by an ASCII configuration filing names of the inputs and outputs of the objects.

5. An object oriented computing system on a computing system, comprising:
objects having dynamically likable inputs and outputs and internal tasks for queuing of data transferred into and out from the objects via said inputs and outputs, respectively; and
an event communication framework providing automated, pattern-based, fully distributable events.

6. The object oriented computing system of claim 5, wherein the inputs and outputs of the objects are provided via CsaConnectable and CsaRemote objects, respectively.

7. The object oriented computing system of claim 6, wherein each data structure associated with the inputs and outputs is described in a separate header file which can be used by every object to be linked.

8. The object oriented computing system of claim 6, wherein each object is a shared library which is dynamically linkable at runtime by an ASCII configuration file containing names of the inputs and outputs of the objects.

9. A method for designing software components in an object oriented computing system, comprising the steps of:
defining input and output events that are fully distributable;
configuring dynamic linkable, semantic-free software components by input and output connections points; and
providing autorouted pattern based fully distributable events based on an event communication framework.

10. A storage medium including object oriented code having an object oriented computing system on a computer platform, comprising:
objects with semanticless, dynamically linkable inputs and outputs; and
an event communication framework providing automated, pattern-based, fully distributable events.

11. The storage medium of claim 10, wherein the inputs and outputs of the objects are provided via CsaConnectable and CsaRemote objects, respectively.

12. The storage medium of claim 11, wherein each data structure associated with the inputs and outputs is described in a separate header file which can be used by every object to be linked.

13. The storage medium of claim 11, wherein each object is a shared library which is dynamically likable at runtime by an ASCII configuration filing names of the inputs and outputs of the objects.

14. A storage medium, comprising:
object oriented code for an object oriented computing system on a computing system;
objects having dynamically linkable inputs and outputs and internal tasks for queuing of data transferred into and out from the objects via said inputs and outputs, respectively; and
an event communication framework providing automated, pattern-based, fully distributable events.

15. The storage medium of claim 14, wherein the inputs and outputs of the objects are provided via CsaConnectable and CsaRemote objects, respectively.

16. The storage medium of claim 15, wherein each data structure associated with the inputs and outputs is described in a separate header file which can be used by every object to be linked.

17. The storage medium of claim 15, wherein each object is a shared library which is dynamically linkable at runtime by an ASCII configuration file containing names of the inputs and outputs of the objects.

18. A method for designing software components in an object oriented computing system having a storage medium including object oriented code, comprising the steps of:
defining input and output events that are fully distributable;
configuring dynamic linkable, semantic-free software components by input and output connections points; and
providing autorouted pattern based fully distributable events based on an event communication framework.
